(19) United States
(12) Patent Application Publication
(10) Pub. No.: US 2013/0254087 A1
(43) Pub. Date: Sep. 26, 2013

(54) Web-based peer-to-peer electronic negotiations

(71) Applicants: Yuval Rooz, Chicago, IL (US); Tom Rickmeyer, Chicago, IL (US); Dominic M. Cairo, Chicago, IL (US); Bhargav Adireddy, Chicago, IL (US); Brian A. Adams, Downers Grove, IL (US); Joseph Walnes, Kenilworth, IL (US)

(72) Inventors: Yuval Rooz, Chicago, IL (US); Tom Rickmeyer, Chicago, IL (US); Dominic M. Cairo, Chicago, IL (US); Bhargav Adireddy, Chicago, IL (US); Brian A. Adams, Downers Grove, IL (US); Joseph Walnes, Kenilworth, IL (US)

(21) Appl. No.: 13/506,022

(22) Filed: Mar. 21, 2012

(51) Int. Cl. G06Q 40/04

(52) U.S. Cl. 705/37

(57) ABSTRACT

Electronic peer-to-peer negotiations are provided which a user accesses via a web-based application. A requestor sends a request for quote. A liquidity provider can respond with a desired price or decline. If the liquidity provider responds, the requestor is given time to accept or decline the trade. The liquidity provider can change the negotiation price while the negotiation is live. If the liquidity provider's price change favors the requestor at the same time the requestor is agreeing to the prevailing negotiation price, the trade will be executed at new price. If the price change has moved the price to a level beyond which the requestor has signaled at the same time the requestor is agreeing to the price, the transaction will not occur. This Abstract is submitted with the understanding that it will not be used to interpret or limit the scope or meaning of the claims.

### FIELD OF THE INVENTION

The present invention relates to web-based peer-to-peer electronic negotiations.

### BACKGROUND OF THE INVENTION

The majority of transactions and volume traded in financial instruments results from interactions taking place by one of two means: (1) an open, centralized, transparent platform where market participants' orders interact anonymously; or (2) a private, peer-to-peer negotiation where counterparties communicate directly with one another.

Up until fairly recently the only centralized venues for trading were open-outcry exchanges where buyers and sellers would come together to trade in person. More recently, open, centralized, transparent electronic platforms that automate the matching of buy orders (bids) and sell orders (offers) have been introduced. Thus, centralized electronic trading methods have evolved from a manually intensive process to a technology-enabled, electronic platform.

Centralized electronic trading platforms allow transparency of supply and demand by displaying order books and/or reporting transactions, providing a vital view into the price discovery process. Participants are able to place orders anonymously and compete to buy and sell financial instruments based on one or more metrics, such as price, order submission time, and quantity.

Electronic trading makes it easier for people in diverse geographic locations to participate more efficiently in the financial markets. With the advent of electronic trading, a trader can be in direct contact simultaneously with multiple markets, from practically anywhere in the world, all without the need to make personal contact with a broker for a trade. The absence of manual intervention required to trade has led to a sharp decline in transactions costs, both in the form of exchange and processing fees as well as brokerage fees. Declining costs, more efficient executions, as well as macroeconomic trends have resulted in a general increase in trading activity as financial products have migrated from traditional floor execution to various electronic platforms. The increase in the number of market participants and lower transaction costs has generally led to more competitive markets and greater liquidity.

Electronic trading is generally based on centralized (host) computers, one or more computer networks, and exchange participant (client) computers. In general, the host platform includes one or more centralized computers. The operations of the host platform typically include order matching, maintaining order books, price information, and managing and updating relevant data stored internally as well as disseminated externally throughout the trading day or as a part of a daily batch process. The host platform is also equipped with external interfaces that maintain contact with market participants and other price information systems.

Using client devices, market participants link to the host exchange through one or more computer networks. A computer network is a group of two or more computers or devices linked together. There are many types of wired and wireless networks such as local area networks and wide area networks. Networks can also be characterized by topology, protocol, and architecture. For example, some market participants may link to the host through a direct connection such as an Integrated Services Digital Network (ISDN) or T1. Some participants link to the host exchange through direct connections and through other common network components such as high-speed servers, routers, and gateways. There are many different types of networks and combinations of network types that can link traders to the host exchange.

The connection between the client device and the host exchange can be established via the Internet, which is a global network of computers. Network servers support hypertext capabilities that permit the Internet to link together collections of documents. User interfaces such as Graphical User Interfaces (GUI) are typically used to navigate the Internet to retrieve relevant documents. Uniform Resource Locators (URLs) are used to identify specific web sites and web pages on the Internet. URLs also identify the address of the document to be retrieved from a network server. The Transfer Control Protocol/Internet Protocol (TCP/IP) is used to transfer information.

The Internet uses a hypertext language referred to as the hypertext mark-up language (HTML). HTML is a commonly used scripting or programming language that permits content providers or developers to place hyperlinks within web pages. These hyperlinks link related content or data, which may be found on multiple Internet host computers. HTML document links may retrieve remote data by use of HyperText Transfer Protocol (HTTP). Alternatively, File Transfer Protocol (FTP) for file transfer, the network news protocol (NNTP) for discussion groups, and the simple mail transport protocol (SMTP) for email or other Internet application protocols can be used. When a user clicks on a link in a web document, the link icon in the document contains the URL that the client application employs to initiate the session with the server storing the linked document. HTTP is the protocol used to support the information transfer.

While technology advances have done an excellent job recreating and improving upon the efficiency and utility of open-outcry financial markets, the same cannot be said for private, peer-to-peer negotiations where counterparties communicate directly with one another. Trading financial instruments in a private, peer-to-peer (i.e. one-to-one) negotiation is often referred to as an over-the-counter (OTC) transaction or OTC negotiation. As used herein, the term OTC is not to be confused with an over-the-counter financial instrument, which is most commonly thought of as a financial instrument that is not traded on an exchange or centrally cleared.

In negotiating an OTC transaction, market participants use various communication mediums to express interest in a particular instrument, quantity, price, and perhaps side (i.e. buy or sell) directly with other market participants. These communications usually occur between two counterparties via a telephone or instant messaging (IM) conversation.

Often, market participants choose to enter into an OTC negotiation rather than placing orders on an exchange to reduce the potential impact large orders may have on the market. While the transparency of exchanges is useful for providing a view into the price discovery process, trades on open electronic platforms also will immediately alert participants to a large supply/demand imbalance, possibly negatively impacting the participants' net price for a transaction.

For example, say 100 shares of a particular stock are available to buy at the best ‘offer’ price and 300 shares are available to sell at the best ‘bid’ price on the order book of an electronic trading platform. If a market participant wishes to buy 1 million shares and places an order to do so on a transparent electronic platform, the participant can expect the order to have a significant impact on the price of the stock and hence the net price the participant can expect to pay for the 1 million shares.

Participants wishing to transact significant orders such as that described above often choose to negotiate directly with a counterparty. This is done to limit the price impact of the order on the broader market for the particular instrument. Most peer-to-peer negotiations follow a similar format that creates a risk of ambiguity and error: The initiating party (referred to as the “requestor” in this document) contacts a desired counterparty (the “liquidity provider” in this document) via phone or IM. The requestor requests either a two-sided quote (buy price and sell price) or a single-sided quote for a specific quantity for a particular instrument. The liquidity provider either indicates it is not interested in this instrument and/or quantity at this time, or acknowledges an interest and responds with the appropriate price(s). This part of the process may be undertaken in one or two steps. Often, the liquidity provider will indicate an interest, but will come back later with a specific price.

The requestor then accepts, rejects or tries to negotiate further. If the requestor is not ready to immediately transact, the negotiation is put into what is effectively a ‘wait and see’ state as the requestor calls other liquidity providers to get their interest and prices or contacts its customer or traders to see what to do next.

These negotiations are prone to multiple types of human-driven errors and have limits on their efficiency because of their intensely manual nature. First and foremost, communication errors are extremely common during OTC negotiations. One frequent source of communication errors with existing OTC negotiation mediums occurs during the initial communication of the order. A common mistake during a telephone call is for a party to either misspeak or mishear the ticker (an alphanumeric string used to describe uniquely a financial instrument) for the financial instrument. For example, the ticker for the iShares Russell 1000 Index exchange traded fund (ETF) offered by iShares, 525 Washington Boulevard, Suite 1405, Jersey City, N.J. 07310 is IWB. The ticker symbol for iShares Russell 3000 Index ETF is IWV. Thus, it is easy to see how a party could either misspeak or mishear the ticker for the equities IWB and IWV.

This same type of mistake occurs via IMs as a mistype or a misread on tickers. For example, the ticker symbol for iShares MSCI Emerging Markets Indx ETF is EEM. The ticker symbol for SPDR Dow Jones Mid Cap ETF offered by State Street Global Advisors, State Street Financial Center, 1 Lincoln Street, Boston, Mass. 02111 is EMM. Again, it is easy to see how a party could mistype or misread the ticker for the equities EMM and EEM.

Oftentimes additional contextual information can help to mitigate the risk of communication errors; however, due to negotiation customs, this additional contextual information may be masked and errors are still common. For example, it is very common for negotiations to occur without the ‘handle’ (integer value) of the instrument involved in a negotiation. A participant initiating a negotiation for a stock with a market that is bid $23.50 and offered $23.51 may receive a quote from the responding counterparty of ‘49 at 51’, implying a bid of $23.49 and an offer of $23.51. While the ‘handle’ of two financial instruments may be enough to differentiate them, this convention may remove this potential safety check.

Furthermore, industry jargon is not consistent across the market, or even within a particular firm. For example, some market participants use the term ‘sold’ to refer to any deal that is agreed to by one party agreeing to the counterparty's resting order, regardless if it is a buy or sell order.

The aforementioned lack of a consistent vocabulary, communication customs, and use of industry jargon are exacerbated by a second inherent flaw in the manual OTC negotiation process: there is no formal, consistent process. Negotiations vary wildly between sets of counterparties and even between a given set of counterparties depending on the day and market conditions.

This lack of a formal process manifests in many failures of the negotiating parties to reach an agreement. One common misunderstanding that results during negotiations is whether a trade has been consummated or not due to what appear to be simultaneous communications between counterparties. These ‘race conditions’ may exist when the liquidity provider wants to cancel or adjust an outstanding quoted price while the requestor wants to execute on the outstanding quoted price. This is frequently an issue when a negotiation is put into a ‘wait and see’ state as the markets move, but can occur at any time during the negotiation process.

This race condition also exists where the liquidity provider adjusts the price such that it is more favorable to the requestor at the same time the requestor communicates its agreement to the negotiation at the prevailing price. It is industry standard for the requestor to receive the price improvement, but this is ultimately an agreement between counterparties rather than a firm rule. Other flaws in negotiations resulting from the lack of a formal procedure include requestors asking liquidity providers for quotes in products in which the liquidity providers are not active, liquidity providers not responding in a desired time window to requestors, and various misunderstandings stemming from the opaque state of a negotiation that has not formally ended and that is revisited at a later time.

These flaws can lead to contentious and expensive disputes between the counterparties. Furthermore, since there is no formal agreement about the procedure, it can be difficult or impossible to determine who is correct. These flaws in negotiations often lead to one side ‘giving in’, which can tarnish the relationship between the two counterparties.

The traditional means through which peer-to-peer negotiations occur—phone calls and IMs—also have significant room for error and are not on par, nor integrated with, the rest of the technology stack used by most professionals to manage their orders. Before the communication and process errors described above even have the potential to occur, there is already room for the counterparties to derail the negotiation by either inefficiently staging the negotiation or potentially even engaging in a negotiation with an undesired counterparty. Requestors generally use various forms of speed dial on phones or software clients that manage IMs to reach out to the liquidity provider of interest. Most requestors have a large number of liquidity providers, with preferences on whom to contact for specific instruments or quantities.

In general, negotiation orders are taken from a computer, translated, negotiated over the phone or by IM, and re-entered into the computer for various reasons, such as maintaining an audit trail for the life cycle of an order. Once a trade has been consummated, at least one of the parties involved is generally required to report the transaction, introducing more possibilities for error. This involves properly reporting information about the transaction such as final trade price, quantity, and side (buy or sell) for each counterparty. This represents another manual translation process prone to the same types of errors previously described, as the requestor and/or counterparty take the agreed upon negotiation details and enter them into their respective systems once again.

Because these types of OTC negotiations are tedious and slow, participants are limited to negotiating a small number of financial instruments at any given time. The structure of OTC negotiations makes it extremely difficult to apply this process to other types of common transactions, such as portfolio management. Large portfolio traders are often the parties who have the most interest in OTC negotiations, as the sizes of their transactions are significant and will undoubtedly have an affect on the instruments in which they are active.

For example, a party may believe that the semiconductor industry is undervalued with respect to the technology sector as a whole, and may therefore wish to buy a large, representative portfolio of semiconductor companies and sell off its significant holdings of technology sector assets. This may involve buying and selling tens or even hundreds of instruments. To transact this strategy effectively, the party will want to transact multiple simultaneously instruments using OTC negotiations to have minimal market impact. This is a daunting task if done using a telephone and/or IMs. Even if the party is able to transact the entire portfolio without any of the errors or miscommunications described above, the time required to effect the entire transaction may mean that the opportunity the participant was trying to capture may no longer be available.

There have been attempts in the market to bridge the gap between traditional OTC trading and modern electronic trading, but none has satisfied the three criteria required for a successful electronic recreation: consistent language, a formal process, and an efficient medium. In addition, all attempts have strayed significantly from the characteristics and spirit of a traditional peer-to-peer negotiation, removing their primary benefits of direct counterparty selection and information privacy to minimize price impact.

One such attempt is the WebICE platform available from the IntercontinentalExchange, Inc., One North End Avenue, New York, N.Y. 10282. The WebICE platform is a client-based application in the Java® programming language that accesses the IntercontinentalExchange (ICE) via the web to download an executable client. Java® is a registered trademark of Oracle Corporation, Inc., 500 Oracle Parkway, Redwood Shores, Calif. 94065. Through the client, the user (requestor) is able to access ICE's central limit order book and “Request For Quote” (RFQ) system. While the word Web is in the name of WebICE, the only web use is to download a client; then, the client handles the communication over the internet with ICE.

On WebICE, a requestor attempting to replicate the phone or IM negotiation process will submit an RFQ. A WebICE RFQ requestor's interest is broadcast anonymously to all liquidity providers that have registered for access to that market, and liquidity providers then have the opportunity to respond with a limit order for the financial instrument, including the requestor's quantity if the quantity is requested. The orders rest, transparent to the entire market place on ICE's central limit order book, removing the primary benefit of an OTC negotiation: information privacy.

The WebICE platform has a number of drawbacks. Initially, both the requestor and the liquidity provider must download and update their version of Java®, which may be incompatible with the user's existing applications creating deployment risk. Even if the WebICE platform is deployed correctly, both the requestor and the liquidity provider must navigate to a foreign application, each with a unique installation present on their respective machines, and navigate within the application to arrive at the functionality they desire. This solution therefore lacks the ability to have an easy mechanism for sharing resources between people or saving a resource for later use.

In addition, at any point another participant not involved in the negotiation may submit an order to ICE's central limit order book that will interact with either the liquidity provider or the requestor and disrupt the negotiation. Also, in order to participate in the negotiation, orders must be submitted to a central limit order book at a static price and therefore the risks of price change that entails are assumed. In order to finally transact with the available liquidity, the requestor must be able to execute on ICE and have arranged all the exchange memberships, clearing requirements, and market access required.

Another attempt is the YellowJacket platform, also available from the IntercontinentalExchange. The YellowJacket platform interprets IM messages by recognizing specific text patterns and extracting order information into an order book-like structure. Orders are presented on a user interface and can be transacted through a central limit order book. The YellowJacket platform uses an installed client and supports a variety of third party IM systems.

Like WebICE, the installation of an installed client introduces the aforementioned drawbacks. While the system attempts to formalize the vocabulary of a pre-execution negotiation, the user is required to learn the vocabulary and accurately type the key words into the IM window to trigger the proper response in the counterparty's application. In other words, YellowJacket provides “keywords” that are interpreted as formal language, but a user must learn this language in order for it to be useful. Even if the user is fluent in YellowJacket's language, there is still room for mistypes—YellowJacket does not provide a medium that uses its language efficiently or without room for ambiguity or the human errors outlined above.

Still another attempt is the Liquidnet platform available from Liquidnet, Inc., 498 Seventh Avenue, 15th floor, New York, N.Y. 10018. The Liquidnet platform is limited in three critical ways: (1) it is only used in the equity market, (2) it can only be used by institutional traders—professional participants that must satisfy strict requirements, and (3) it is only usable for trades that meet block trade criteria. Liquidnet enables these institutional equity participants to trade with each other anonymously via the Internet. To connect via the Internet, participants still have to use Liquidnet's proprietary trading platform. Thus, the Liquidnet platform has most of drawbacks mentioned above with regard to installed clients.

Thus, it is seen that these prior attempts are essentially requests to execute electronically a trade—not true electronic RFQs. In addition, these prior attempts require the user to download and update software at its client devices, which may be incompatible with the user's existing applications creating deployment risk. The user must navigate to a foreign application, and are no longer able to use the browser functionality. For example, bookmarkable URLs are a standard mechanism for sharing resources between participants. A specific portfolio, RFQ or trade can be assigned to a URL. If this URL were e-mailed to another participant, that participant would be able to see the same thing that the sender sees. Still further, for users that cannot download executables from the Internet due to firewalls or other security, these users will be unable to get the most recent software and may be excluded from accessing the market. Finally, the long and tedious process of IT and security approvals for external applications can take significant amounts of time.

### SUMMARY OF THE INVENTION

The present invention improves upon existing peer-to-peer negotiations and bridges the gap between traditional phone or IM negotiations and modern electronic trading. The present invention is the first true electronic peer-to-peer negotiation platform. In accordance with the principles of the present invention, a peer-to-peer electronic negotiation application is provided. A user accesses the peer-to-peer electronic negotiation application via a web-based application. A requestor sends a request for quote. The request for quote is displayed to a liquidity provider. The liquidity provider can choose to respond with a desired price or decline to enter into a negotiation. If the liquidity provider responds with a negotiation price, the requestor is given a specified amount of time to accept or decline the trade.

The liquidity provider has the ability to change the negotiation price while the negotiation is live and the requestor has not cancelled or accepted the negotiation. If the liquidity provider's price change favors the requestor as the requestor is agreeing to the prevailing negotiation price, the trade will be executed at the new price resulting in a price improvement to the requestor. If the price change has moved the price to a level beyond which the requestor has explicitly signaled the desire to trade as the requestor is agreeing to the prevailing negotiation price, the transaction will not occur at the new price and the requestor is protected from the adverse price move. The risk of the requestor clicking in an attempt to trade in a situation where the negotiation price has moved outside of their agreed-upon best price is removed.

This Summary introduces concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWING

FIG. 1 is a schematic diagram using a streaming web-browser based trading system.

FIG. 2 is a screen shot showing a requestor side trading display.

FIG. 3 is a screen shot showing a liquidity provider side trading display.

FIG. 4 is a state diagram for the requestor side and the liquidity provider side.

FIG. 5 is a screen shot showing a requestor ‘new’ state.

FIG. 6 is a screen shot showing a requestor ‘requesting’ state.

FIG. 7 is a screen shot showing a requestor ‘open’ state.

FIG. 8 is a screen shot showing a requestor ‘trading’ state.

FIG. 9 is another screen shot showing a requestor ‘trading’ state.

FIG. 10 is a screen shot showing a requestor ‘trade rejected’ state.

FIG. 11 is a screen shot showing a requestor ‘expired’ state.

FIG. 12 is a screen shot showing a requestor ‘canceling’ state.

FIG. 13 is a screen shot showing a requestor ‘canceled’ state.

FIG. 14 is a screen shot showing a requestor ‘not interested’ state.

FIG. 15 is a screen shot showing a requestor ‘trade confirmation’ state.

FIG. 16 is a screen shot showing a liquidity provider ‘new’ state.

FIG. 17 is a screen shot showing a liquidity provider ‘not interested’ state.

FIG. 18 is a screen shot showing a liquidity provider ‘open’ state.

FIG. 19 is a screen shot showing a liquidity provider ‘trade accepted’ state.

FIG. 20 is a screen shot showing a liquidity provider ‘not interested’ state.

FIG. 21 is a screen shot showing a liquidity provider ‘canceled’ state.

FIG. 22 is a screen shot showing a liquidity provider ‘price moved’ state.

FIG. 23 is a screen shot showing a liquidity provider ‘price improvement’ feature.

FIG. 24 is another screen shot showing the liquidity provider ‘price improvement’ feature.

FIG. 25 is another screen shot showing the liquidity provider ‘price block’ feature.

### DETAILED DESCRIPTION OF A PREFERRED EMBODIMENT

### Introduction

In order for peer-to-peer negotiations to become automated, a formalized language and process must be established and a proper medium must exist for such negotiation to take place. Furthermore, these three criteria must be satisfied while still maintaining the benefits and characteristics of a peer-to-peer peer-to-peer negotiation.

The present invention provides for electronic peer-to-peer negotiation systems that can be accessed through a standard web browser, with sufficient speed and the improved process required for real-time electronic peer-to-peer negotiations. The present invention also corrects existing flaws in peer-to-peer negotiation language and process, as well as provides a medium in which to negotiate to bridge the gap between peer-to-peer negotiations and modern electronic trading. The present invention is the first true electronic peer-to-peer negotiation platform.

In accordance with the principles of the present invention, a peer-to-peer electronic negotiation application is provided. A user accesses the peer-to-peer electronic negotiation application via a web-based application. A requestor sends a request for quote. The request for quote is displayed to a liquidity provider. The liquidity provider can choose to respond with a desired price or decline to enter into a negotiation. If the liquidity provider responds with a negotiation price, the requestor is given a specified amount of time to accept or decline the trade.

The historic challenges in dealing with situations where the liquidity provider is changing the negotiation price at the same time the requestor is agreeing to the prevailing negotiation are now addressed. If the liquidity provider's price change favors the requestor as the requestor is agreeing to the prevailing negotiation price, the trade will be executed at new price and the requestor gets the price improvement, as is industry standard. If the price change has moved the price to a level beyond which the requestor has explicitly signaled the desire to trade as the requestor is agreeing to the prevailing negotiation price, the transaction will not occur at the new price and the requestor is protected from the adverse price move. Furthermore, the risk of the requestor clicking in an attempt to trade in a situation where the negotiation price has moved outside of the agreed-upon price is removed.

This invention is implemented as a web-based application, which provides significant benefits over traditional desktop client applications. Virtually every desktop computer now has a web-browser pre-installed. To gain access to an application, the user need only type a URL in the address bar. The web-browser provides a secure restricted environment for the application, ensuring the application cannot access files on the local disk. No additional software is required to run the application.

In addition, Web-based applications allow for seamless upgrades. The web-application is updated server side (by the application provider) and web-browsers will immediately start using the new software. There is no additional upgrade step required on the desktop (consumers). When the software on the server is upgraded, the web-browser clients detect this and automatically reload.

Still further, use of Web-based applications allows for use across several platforms. Web-applications work across many operating systems (such as, for example, Microsoft Windows available from Microsoft Corporation, One Microsoft Way, Redmond, Wash. 98052; Apple Mac OS-X available from Apple, Inc., 1 Infinite Loop Cupertino, Calif. 95014; the LINUX operating system administered by The Linux Foundation, 1796 18th Street, Suite C, San Francisco, Calif. 94107; and the like) as well as a wide array of mobile devices, such as smart phones (for example, iPhone smart phone available from Apple; smart phones operating on the Android operating systems available from Google Inc., 1600 Amphitheatre Parkway, Mountain View, Calif. CA 94043; Blackberry devices available from Research in Motion, 295 Phillip Street, Waterloo, Ontario, Canada N2L 3W8; and the like) and tablet devices (for example, iPad devices available from Apple; the Galaxy Tab available from Samsung Electronics Co., Ltd. 1320-10, Seocho 2-dong, Seocho-gu Seoul 137-857, South Korea; the Streak available from Dell Inc., One Dell Way, Round Rock, Tex. 78682; XOOM available from Motorola Mobility, Inc., 600 North U.S. Highway 45, Libertyville, Ill. 60048; and the like) as well as laptop computers, personal computers, and the like.

Applications can be referenced by different URLs. Users can easily run multiple applications alongside each other in multiple browser windows, and use different versions of the application, by switching the URLs. For example, a different URL can be used to preview new ‘beta’ features.

These advantages mean that the application can be rapidly deployed into a corporate IT environment with no additional changes to the existing IT infrastructure and within the bounds of corporate policies.

### Web-Based Negotiations

Providing the fast and continuous communication between counterparties necessary to implement the race condition protections included in this invention is not possible using traditional web applications. This is because of the request-response polling nature of web applications—browsers must repeatedly reconnect and ask for the next batch of data or update from the other side, leading to unnecessary overheads (for example, Transmission Control Protocol (TCP) SYNchronize and HyperText Transfer Protocol (HTTP) headers) for small but frequent payloads of data. Although many sites offer an illusion of streaming, under the hood, they are implemented as polling.

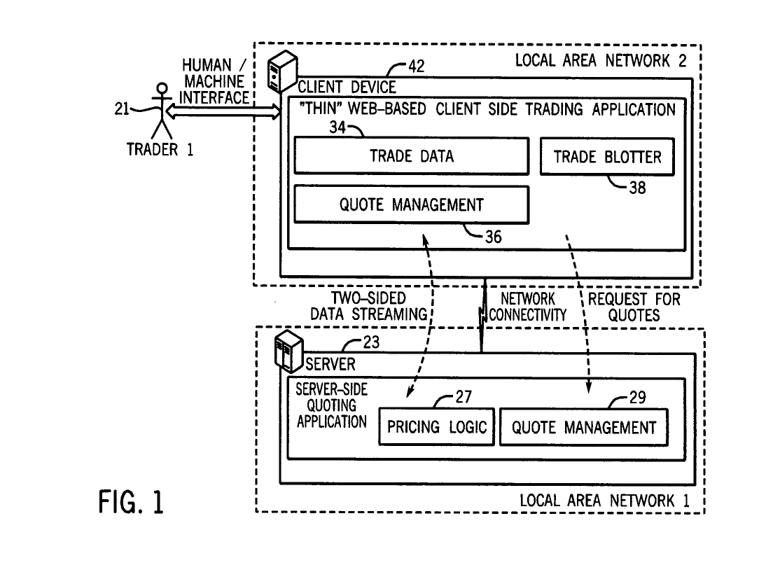

FIG. 1 is a schematic diagram of a thin-client, streaming web-based peer-to-peer negotiation system able to overcome this significant technical challenge. An always-open HTTP protocol such as WebSockets enables Web pages to use the protocol for two-way communication with a remote host without the overhead of creating a new connection for every piece of data. These protocols provide for one or more bi-directional, full-duplex communications channels, over a single TCP socket. An example WebSockets is described in detail, below.

The thin, web-based, client-side negotiation application 42 includes a quote management component 36, a trade data component 34, and a trade blotter component 38. The thin, web-based, client-side trading application 42 is a web page that can be built for example using JavaScript running in a Chrome web browser available from Google Inc., 1600 Amphitheatre Parkway, Mountain View Calif. 94043, hosted on an x86 desktop machine running the Windows operating system. In this system, a user or trader 21 initiates a negotiation by sending a negotiation request data structure to the negotiation server 23 via an always-open communication protocol such as Websockets.

An external marketplace provides market data using UDP/IP multicast to the negotiation participant in local area network 1 (LAN 1). A negotiation server 23 includes a pricing logic 25 and quote management component 27. The negotiation server 23 can be, for example, a UNIX x86 server running the Linux operating system, which receives UDP multicast traffic using a market data component built using for example the C++ programming language. This component then parses the contents of the UDP packet into a negotiation data structure (for example, trading instrument, price, quantity, and side), caches the data, and pushes the negotiation data using an always open communication channel such as WebSockets to a thin, web-based, client-side negotiation application. This data is streamed to the client device 42 without the client device requesting any updates.

The web client receives the negotiation update via WebSockets, and refreshes the user graphical interface display with this data. The trader or user 21 may then take action on this information and can decide proceed as desired with the negotiation using the graphical interface component. This action is then sent to the negotiation server 23 over WebSockets, which performs validation logic against the action and notifies the client application 42 that the negotiation is complete.

The bidirectional, full-duplex communication web-based trading TCP stack of the present invention does not rely on the traditional polling mechanism. Instead of using HTTP/SSL, the bidirectional, full-duplex communication web-based trading OSI stack of the present invention uses protocols such as for example WebSockets/SSL, where the web client and trading server continuously share information without the need for polling. An example of a streaming technology that can stream data into a web-browser is the WebSockets Application Programming Interface (API) available from the World Wide Web Consortium (W3C), 32 Vassar Street, Room 32-G515, Cambridge, Mass. 02139. See http://www.w3.org/TR/websockets/ (accessed 19 Mach 2012). While the WebSockets API is described below, it is to be considered an example of a streaming technology that can be incorporated into the present invention.

To enable Web applications to maintain bidirectional communications with server-side processes, the following interface can be utilized:

[Constructor(in DOMString url, in optional DOMString protocol)]
interface WebSocket {

readonly attribute DOMString URL;
// ready state
const unsigned short CONNECTING = 0;
const unsigned short OPEN = 1;
const unsigned short CLOSED = 2;
readonly attribute unsigned short readyState;
readonly attribute unsigned long bufferedAmount;
// networking

attribute Function onopen;
attribute Function onmessage;
attribute Function onclose;

boolean send(in DOMString data);
void close( );

};
WebSocket implements EventTarget;

The WebSocket(url, protocol) constructor takes one or two arguments. The first argument, url, specifies the URL to which to connect. The second, protocol, if present, specifies a sub-protocol that the server must support for the connection to be successful. The sub-protocol name must be a non-empty American Standard Code for Information Interchange (ASCII) string with no control characters in it (that is, only characters in the range U+0020 to U+007E).

When the WebSocket) constructor is invoked, the User Agent (UA) runs the following steps: a WebSocket URL's components are parsed from the url argument, to obtain host, port, resource name, and secure. If this fails, a syntax error exception is thrown and these steps are aborted. If port is a port to which the UA is configured to block access, then a security error exception is thrown. (UAs typically block access to well-known ports like Simple Mail Transfer Protocol (SMTP).) If protocol is present but is either the empty string or contains characters with Unicode code points less than U+0020 or greater than U+007E (that is, any characters that are not printable ASCII characters), then a syntax error exception is thrown and these steps are aborted. Origin is let to be the ASCII serialization of the origin of the script that invoked the WebSocket( ) constructor, converted to ASCII lowercase. A new WebSocket object is returned, and these steps are continued in the background (without blocking scripts). A WebSocket connection to a host host is established, on port port (if one was specified), from origin, with the flag secure, with resource name as the resource name, and with protocol as the protocol (if it is present). If “establish a WebSocket connection” fails, “fail the WebSocket connection” is triggered, which then invokes “close the WebSocket connection”, which then establishes that the “WebSocket connection is closed”, which fires the close event. When the WebSocket connection is closed, the UA must queue a task to first change the readyState attribute's value to CLOSED (2), and then fire a simple event named close at the WebSocket object. (If the close( ) method was called, the readyState attribute's value will already be set to CLOSED (2) when this task runs.) This constructor must be visible when the script's global object is either a Window object or an object implementing the WorkerUtils interface.

The URL attribute must return the result of resolving the URL that was passed to the constructor. (It does not matter what it is resolved relative to, since it is an absolute URL.) The readyState attribute represents the state of the connection. The readyState attribute can have the following values:

CONNECTING (numeric value 0)
The connection has not yet been established.

OPEN (numeric value 1)
The WebSocket connection is established and communication is possible.

CLOSED (numeric value 2)
The connection has been closed or could not be opened.
   When the object is created its readyState must be set to CONNECTING (0).

The send(data) method transmits data using the connection. If the readyState attribute is CONNECTING, it must raise an invalid state error exception. If the data argument has any unpaired surrogates, then it must raise syntax error. If the connection is established, and the string has no unpaired surrogates, then the user agent must send data using the WebSocket. If the data cannot be sent, for example because it would need to be buffered but the buffer is full, the user agent must close the WebSocket connection. The method must then return true if the connection is still established (and the data was queued or sent successfully), or false if the connection is closed (that is, because the user agent just had a buffer overflow and failed to send the data).

The close( ) method must close the WebSocket connection or connection attempt, if any, and change the readyState attribute's value to CLOSED (2). If the connection is already closed, it must do nothing. Closing the connection immediately causes a task to be queued to fire a close event.

The bufferedAmount attribute must return the number of bytes that have been queued but not yet sent. If the connection is closed, this attribute's value will only increase with each call to the send( ) method (the number does not reset to zero once the connection closes). The following Table sets forth the event handlers that must be supported, as IDL attributes, by all objects implementing the WebSocket interface:

TABLE
Event Handlers That Must Be Supported

| Event handler | Event handler event type |
|---|---|
| onopen | open |
| onmessage | message |
| onclose | close |

When the WebSocket connection is established, the UA must queue a task to first change the readyState attribute's value to OPEN (1), and then fire a simple event named open at the WebSocket object. When a WebSocket message has been received with text data, the user agent must create an event that uses the MessageEvent interface, with the event name message, which does not bubble, is not cancelable, has no default action, and whose data attribute is set to data, and queue a task to check to see if the readyState attribute's value is OPEN (1), and if so, dispatch the event at the WebSocket object. When the WebSocket connection is closed, the user agent must queue a task to first change the readyState attribute's value to CLOSED (2), and then fire a simple event named close at the WebSocket object. (If the close( ) method was called, the readyState attribute's value will already be set to CLOSED (2) when this task runs.) The task source for tasks queued is the WebSocket task source.

A WebSocket object with an open connection must not be garbage collected if there are any event listeners registered for message events. If a WebSocket object is garbage collected while its connection is still open, the user agent must close the WebSocket connection. Again, while the WebSockets API has been described as an example of a streaming technology, the present invention is by no means limited to such specific implementation.

### Peer to Peer Electronic Negotiation

The peer-to-peer electronic negotiation system includes a requestor side and a liquidity provider side. When used herein, the term liquidity provider is a party who responds to the negotiation request. The liquidity provider can be, but is not necessarily a market maker. The requestor side sends a request for quote (RFQ). The requestor RFQ is displayed to a liquidity provider. The liquidity provider can choose to respond with a desired price or decline to enter into a negotiation. If the liquidity provider responds with a negotiation price, the requestor is given a specified amount of time to accept or decline the trade. The liquidity provider side may change the negotiation price.

In the case where the requestor attempts to act on the existing negotiation price at the same time the liquidity provider is changing the price, if the price change favors the requestor, the trade will be executed at new price resulting in a price improvement for the requestor in accordance with industry standards. If the new price change leads to the negotiation price being outside of the acceptable range of the requestor, the transaction will not occur at the new price and the requestor is protected from the adverse price move.

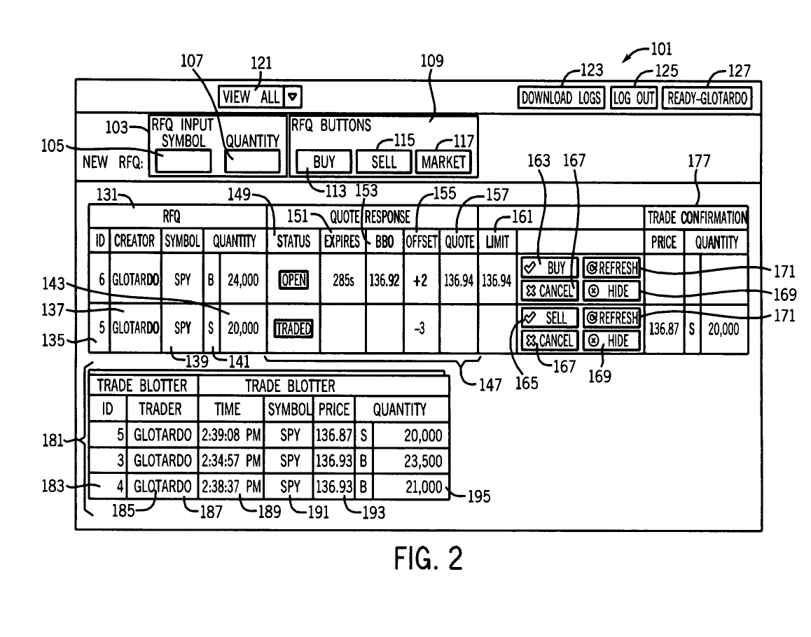

The following will show the overview of the system with available functionality, state diagram with images of every state, and specific chart flow of unique features. In more detail, referring to FIG. 2 a screen shot showing the requestor side trading display 101 is seen. Throughout this description, various elements are set apart using a “ ‘ ’ ” designation; this is because the labels chosen for these elements are for convenience and should not be used in narrowing or defining the functionality of such elements. The requestor side trading display 101 includes a RFQ input 103. The symbol for which a quote is being requested is entered into a ‘symbol input’ box 105. The symbol will turn red if it is not tradable by the requestor. The quantity for which an RFQ is triggered is entered into a ‘quantity input box’ 107. The quantity field will check for legal quantity input values. For example, decimal points will not be accepted. In addition, a ‘fat-finger’ limit check can be provided. The fat-finger limit is programmable and, if exceeded, the ability to send an RFQ will be disabled.

The requestor side trading display 101 includes ‘RFQ’ buttons 109. The ‘RFQ’ buttons 109 provide the ability to send the RFQ to the liquidity provider for quoting. A ‘RFQ buy’ button 113 sends an RFQ indicating the requestor's interest to buy the quantity entered for the specific symbol. An ‘RFQ sell’ button 115 sends an RFQ indicating the requestor's interest to sell the quantity entered for the specific symbol. An ‘RFQ market’ button 117 sends an RFQ to get a two-sided market (i.e. buy and sell price) for the quantity entered for the specific symbol.

The requestor side trading display 101 includes a ‘select view’ button 121. Two main views are provided. A ‘trader’ view includes only RFQs sent by the requestor that have not yet been ‘hidden’ from view. An ‘all’ view shows RFQs that have not yet been ‘hidden’ that were sent by anyone within a group of individuals from the requestor's side. A ‘download logs’ button 123 allows the requestor to download a recap of the data that was communicated between both parties. A ‘log out’ button 125 allows the requestor to logout at the end of the trading day. A new authentication will be required in order to login. A ‘login status’ button 127 shows the requestor if the requestor is logged in. If the requestor was disconnected from the server, this area will be painted in red.

The requestor side trading display 101 includes a ‘RFQ’ display 131. The RFQ display 131 includes the RFQ ‘ID’ column 135—the serial number used for the RFQ that is unique for each trading session and RFQ. A requestor or ‘creator’ column 137 displays the requestor's username who is logged into the system. A ‘symbol’ column 139 displays the RFQ ticker symbol. A ‘side’ column 141 displays the requestor's side of the RFQ (buy or sell). A ‘quantity’ column 143 displays the RFQ quantity.

The requestor side trading display 101 includes a ‘quote response’ display 147. The ‘quote response’ display 147 includes a ‘status’ column 149 that displays the negotiation status. This can include, for example, traded, open, canceled, canceling, trading, price moved, and expired. An ‘expires’ column 151 displays a countdown timer which indicate for how long the RFQ will be ‘live’. A ‘BBO’ price column 153 displays the liquidity provider's best-bid/best-offer prices. An ‘offset’ column 155 indicates the spread between the BBO and the quote given for the negotiation. In this example, this is quoted in pennies. A ‘quote’ column 157 displays the quote price given as a response to the RFQ.

As the requestor hovers over the ‘trade’ button, the requestor locks in a price that appears in a ‘limit’ column 161. This limit price is equal to the quote price at the time the requestor hovered over the ‘trade’ button and represents the worst price at which the trade will be executed. This prevents the requestor from trading at an undesired price. As explained in more detail below, as the limit price is locked and the quote price goes against the requestor as a result of changes in the market, the trade button becomes disabled and will not allow the requestor to trade; if the quoted price goes in favor of the requestor and the requestor clicks the ‘trade’ button, the price improvement will be given to the requestor. If the requestor wants to update the limit price to the quoted price, the requestor can move the mouse away from the ‘trade’ button and then hover again to lock in a new limit price.

A ‘trade’ button is used to trade the RFQ. This could be a buy 163 or a sell 165. A ‘cancel’ button 167 can be used at any time to cancel the negotiation. Once the negotiation is not live anymore, the requestor can hide the RFQ entry by selecting a ‘hide’ button 169. Once the negotiation is not live anymore and has not traded, the requestor can ask for a new identical RFQ by selecting a ‘refresh’ button 171.

The requestor side trading display 101 includes a ‘trade confirmation’ display 177. This trade confirmation 177 is in addition to the trade blotter detailed below. This trade confirmation 177 provides the final price (which could be different from the limit price if there was price improvement) and the final quantity traded with the requestor.

The requestor side trading display 101 includes a ‘trade blotter’ 181. The trade blotter 181 provides the requestor with the recap of the trades. The trade blotter 181 can include an ID 183, ‘trader’ 185, ‘time of trade’ 187, ‘symbol’ 189, ‘price’ 191, ‘side’ 193, and ‘quantity’ 195.

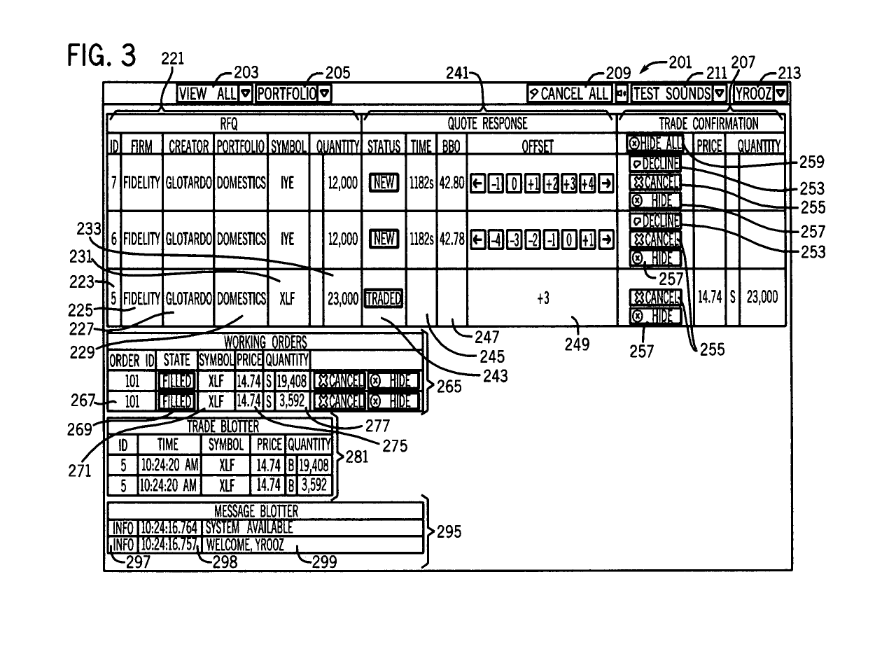

Referring to FIG. 3, a screen shot showing a liquidity provider trading display 201 is seen. The liquidity provider trading display 201 includes a ‘view’ selector 203. The ‘view’ selector 203 allows the liquidity provider to see the liquidity provider's trades, the entire group's trades, or the trades of any subset of liquidity provider desired. A ‘portfolio’ view 205 allows the liquidity provider to choose between different pre-defined groups of instruments referred to as portfolios. The liquidity provider can thus trade a combination of any number of individual quotes on any number of financial instruments. A ‘cancel all’ button 207 cancels all outstanding negotiations. A ‘sound on/off’ button 209 turns alarm sounds on or off. A ‘test sound’ dropdown 211 allows the liquidity provider to test the different sounds used for various notification purposes. A user log in 213 shows the liquidity provider using the application.

The liquidity provider trading display 201 includes an ‘RFQ’ display 221. The ‘RFQ’ display 221 includes an ‘ID’ column 223 that uniquely identifies the RFQ. A ‘requestor’ column 225 shows which counter party sent the RFQ. A ‘creator’ column 227 shows which requestor on the requestor side created the RFQ. A ‘portfolio’ column 229 shows to which portfolio the RFQ belongs. A ‘symbol’ column 231 displays the RFQ ticker symbol. A ‘side+quantity’ column 233 shows the side the liquidity provider would trade if the RFQ were executed in addition to the quantity.

The liquidity provider trading display 201 includes a ‘quote response’ display 241. The ‘quote response’ display 241 includes a ‘status’ column 343 that shows the different status in the negotiation life: for example, new, open, traded, not interested, canceled, etc. A ‘time’ column 345 shows the time until a ‘new’ RFQ expires. When the RFQ expires, an automatic “not interested” is sent to the requestor. A ‘BBO’ column 347 shows the liquidity provider's best bid/offer prices. An ‘offset’ column 349 can have three main states: a ‘new’ state shows the ‘offset’ buttons which can also move up or down by increments useful to the liquidity provider—this example uses pennies; an ‘open’ state shows the current offset sent to the requestor in addition to ‘offset’ buttons in order to change the offset while the order is still ‘live’; a ‘traded’ state shows the offset used to create the trade. The liquidity provider is not limited to providing a response to an RFQ using offsets or any particular manual price selection method; automated negotiation responses are also possible.

A ‘decline’ button 253 sends a ‘not interested’ to the requestor side. A ‘cancel’ button 255 cancels a live negotiation as long as the RFQ was not traded. A ‘hide’ button 257 hides a “traded/canceled” RFQ. A ‘hide all’ button 259 hides all RFQs.

The liquidity provider trading display 201 includes a ‘trade confirmation’ column 263. The ‘trade confirmation’ column 263 shows the quantity/side/price of a ‘traded’ RFQ.

The liquidity provider trading display 201 includes a ‘working orders’ display 265. The ‘working orders’ display 265 shows the history of negotiations, and can give order ‘ID’ 267, ‘state’ 269, ‘symbol’ 271, ‘price’ 273, and ‘quantity’ 277.

The liquidity provider trading display 201 includes a ‘trade blotter’ 281. The ‘trade blotter’ 281 shows the history of negotiations that resulted in trades and can give ‘ID’ 283, ‘time’ 285, ‘symbol’ 287, ‘price’ 289, ‘side’ 291, and ‘quantity’ 293. A message blotter 295 shows messages sent. Fields can include ‘type’ 297, ‘time’ 298, and ‘message’ 299.

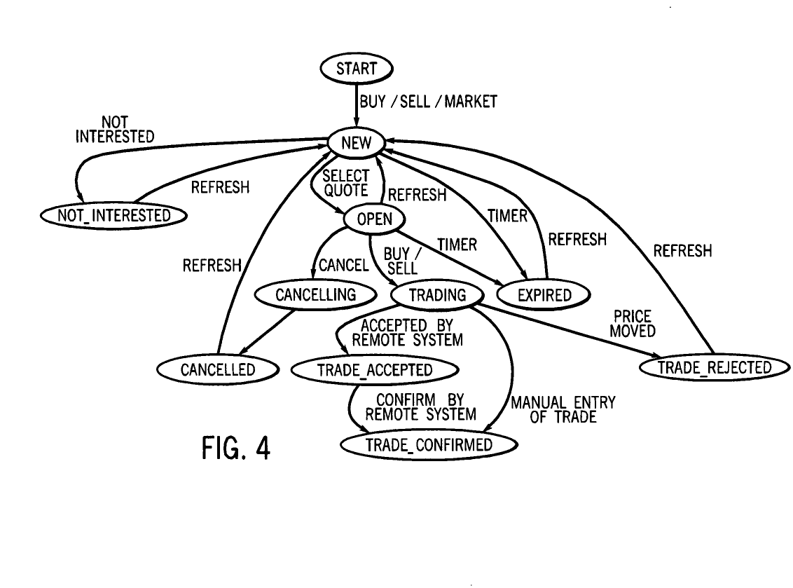

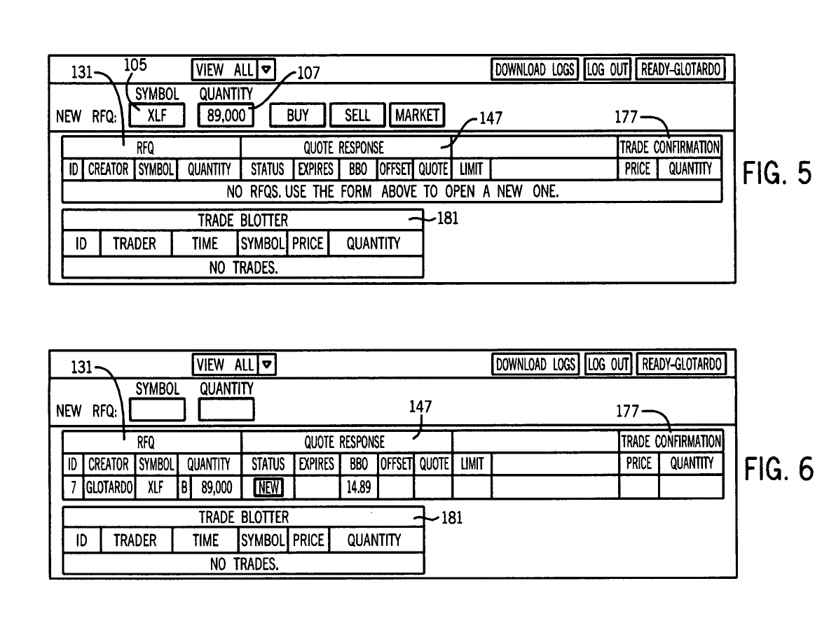

FIG. 4 is a state diagram for the requestor side and the liquidity provider. The state diagram for both the requestor side and the liquidity provider are similar, with the liquidity provider excluding the ‘trading’, ‘canceling’, and ‘expired’ states. The state diagram of FIG. 4 is used in conjunction with FIGS. 5-26 where screen shots showing the states from the requestor side and the liquidity provider side are seen.

Referring to FIG. 5, a screen shot showing a requestor ‘new’ state is seen. When a requestor wants to send an RFQ, the requestor must enter a valid symbol in order to have the ‘RFQ’ buttons enabled. A valid symbol follows ticker conventions and is tradable by the liquidity provider. In addition, the quantity must also be a valid quantity in order to enable buttons. If the quantity is over a preconfigured limit, if the requestor has entered a nonintegral quantity or if an ‘untradeable’ symbol is requested, the ‘RFQ submission’ buttons are not active.

Referring to FIG. 6, a screen shot showing a requestor ‘requesting’ state is seen. The negotiation enters the ‘requesting’ state after an RFQ has been submitted. The ‘requesting’ state ends when the requestor responds with a quote, responds that the requestor is not interested or if the requestor does not respond and the state defaults to ‘not interested’.

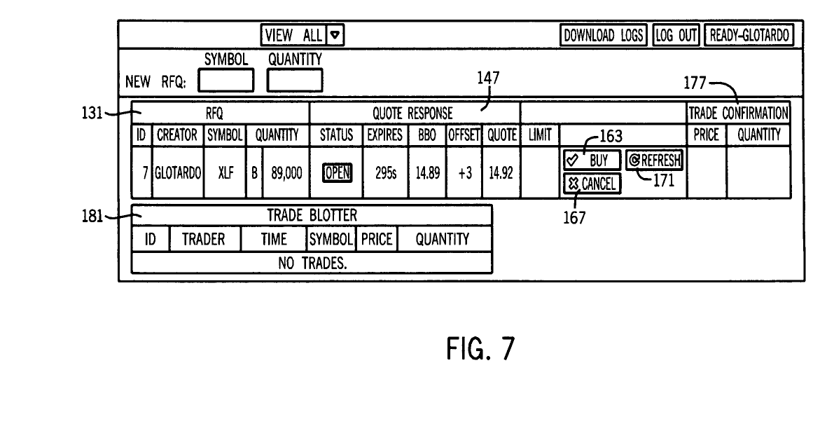

Referring to FIG. 7, a screen shot showing a requestor ‘open’ state is seen. Once the liquidity provider responds with interest, the requestor side has a limited time to decide whether or not to accept the quote. Options available for the requestor include trade (buy or sell, depending on the requested side), refresh or cancel.

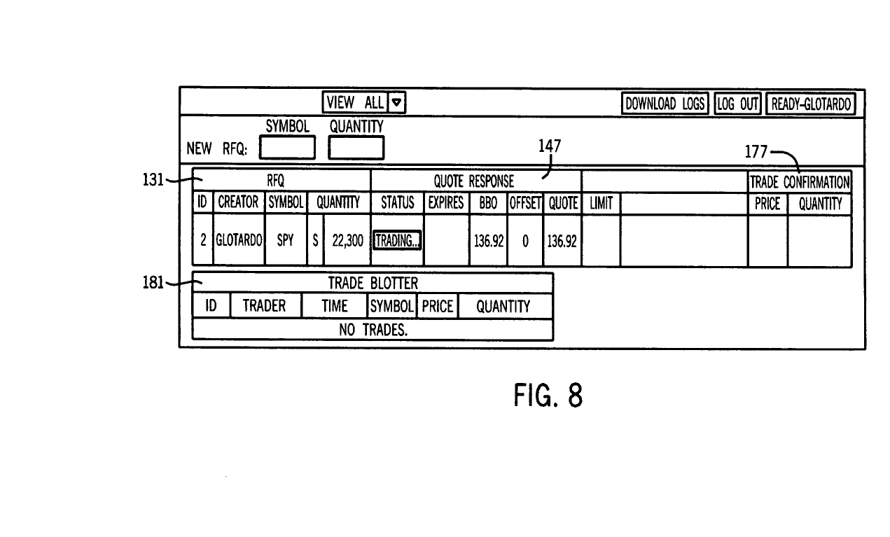

Referring to FIG. 8, a screen shot showing a requestor ‘trading’ state is seen. Once a requestor has chosen to trade by clicking the ‘buy’ or ‘sell’ button, the negotiation enters the ‘trading’ state as the interest is communicated to the requestor. At this point, the requestor may have certain regulatory requirements to satisfy before returning the final quantity (e.g. Regulation National Market System (NMS), 17 C.F.R. ¶¶ 200, 201, 230, 240, 242, 249, and 270) and having the negotiation enter the ‘traded’ state.

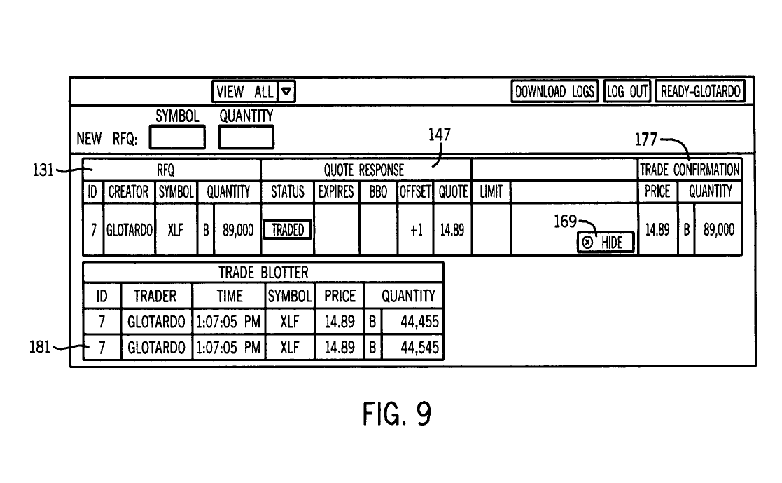

Referring to FIG. 9, another screen shot showing a requestor ‘traded’ state is seen. Once a negotiation has concluded and the trade is entered, the negotiation is no longer active. The appropriate details of the trade are displayed, and an option of hiding the trade from the main view appears. The trade will remain in trade blotters for users who have selected a view for which this trade belongs

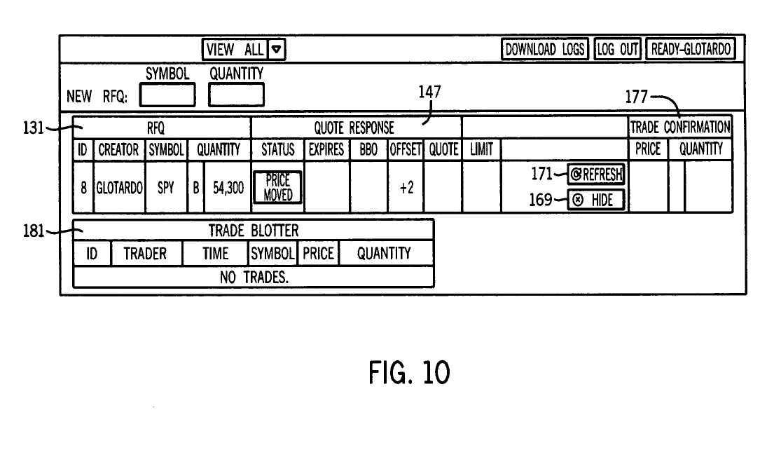

Referring to FIG. 10, a screen shot showing a requestor ‘trade rejected’ state is seen. After clicking the buy/sell, if the price change has moved the price to a level beyond which the requestor has signaled the desire to trade, the client will get a reject stating the price moved. The RFQ can be resubmitted using the ‘refresh’ button.

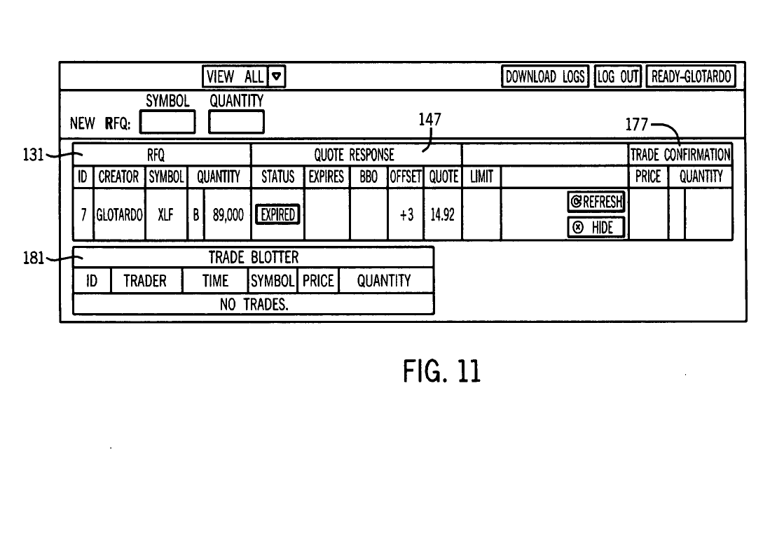

Referring to FIG. 11, a screen shot showing a requestor ‘expired’ state is seen. An RFQ will expire after a specific time has expired since the ticket was open without the negotiation being completed.

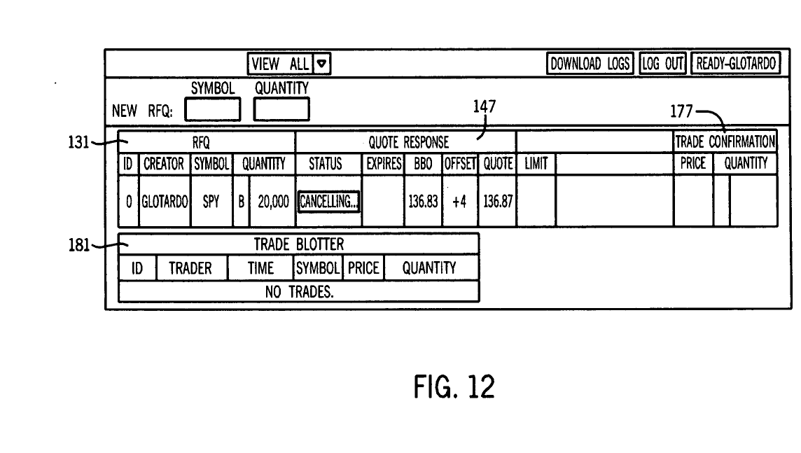

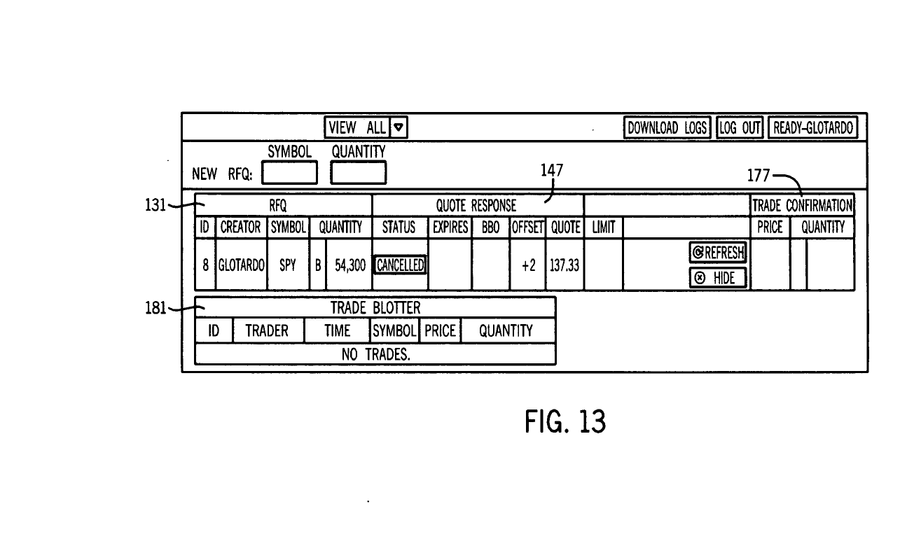

Referring to FIG. 12, a screen shot showing a requestor ‘canceling’ state is seen. The negotiation is in the ‘canceling’ state while the cancel request is being communicated to the requestor. FIG. 13 shows a requestor ‘canceled’ state. The negotiation enters the ‘canceled’ state once one user has received an acknowledgment from the other party that the initial cancel request has been received and processed.

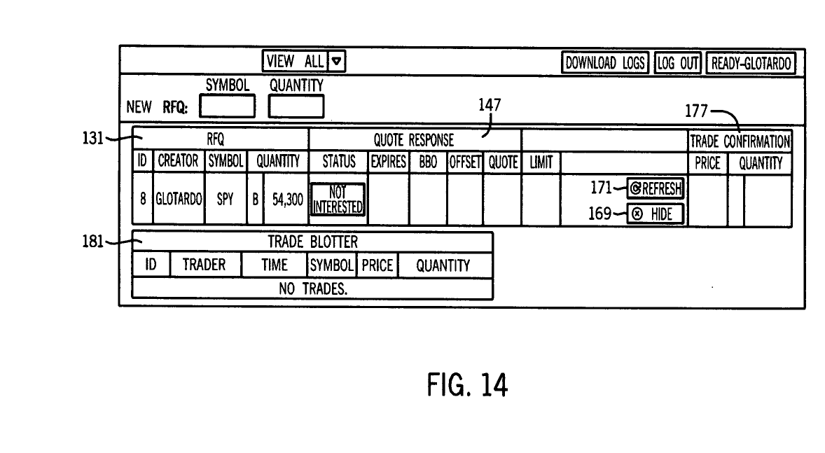

Referring to FIG. 14, a screen shot showing a requestor ‘not interested’ state is seen. Not interested indicates that the liquidity provider was not interested in the symbol and/or quantity of the original RFQ or did not respond in a pre-defined amount of time. This is not an active state. The requestor can re-submit the RFQ using the ‘refresh’ button or hide the RFQ from the main view using the ‘hide’ button.

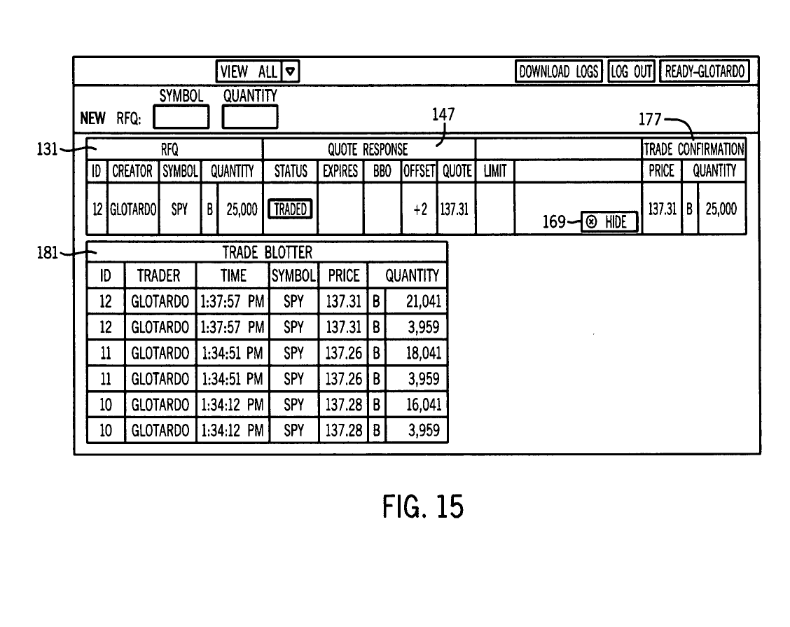

Referring to FIG. 15, a screen shot showing a requestor ‘trade confirmation’ state is seen. The trade blotter contains the final trade details for RFQs that resulted in a trade matching the criteria of the selected view.

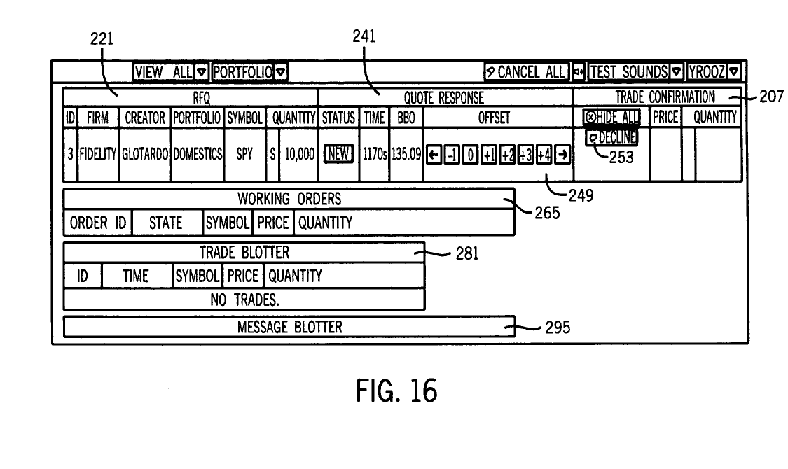

Referring to FIG. 16, a screen shot showing a liquidity provider ‘new’ state is seen. An RFQ initially enters the system in the ‘new’ state. At this point, the liquidity provider may choose to decline to enter into a negotiation using the ‘decline’ button. The user also has various ways of responding with their desired price to the initiator. For example, the liquidity provider is presented with buttons for offsets from BBO with which to respond.

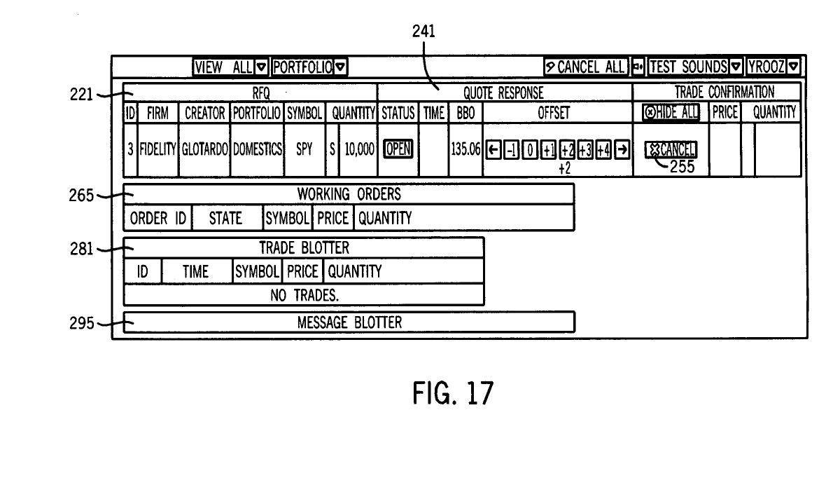

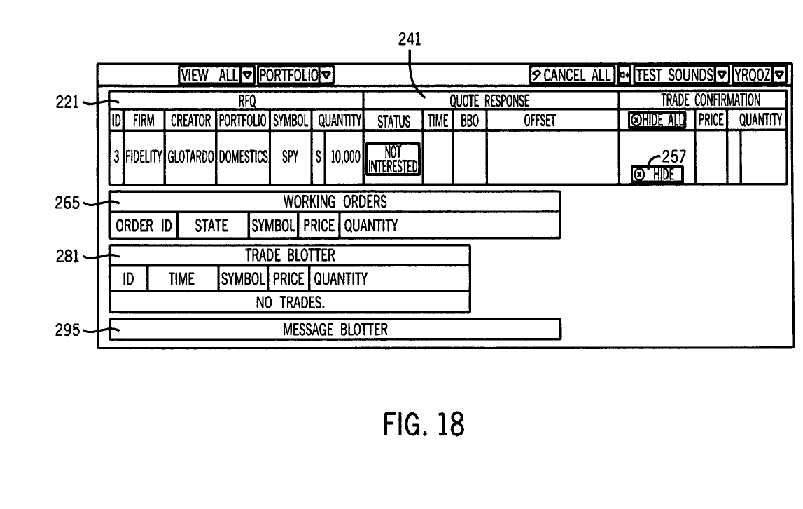

Referring to FIG. 17, a screen shot showing a liquidity provider ‘open’ state is seen. Once a liquidity provider has responded with a price, a negotiation enters the ‘open’ state. While in the ‘open’ state, the liquidity provider can cancel a negotiation at any point in time using the ‘cancel’ button or modify the negotiation price. For example, in FIG. 18 the liquidity provider can change the offset to change the negotiation price the requestor receives.

Referring to FIG. 18, a screen shot showing a liquidity provider ‘not interested’ state is seen. If a liquidity provider chooses to decline the negotiation using the ‘decline’ button, the negotiation is no longer active and enters the ‘not interested’ state. The liquidity provider can hide this RFQ using the ‘hide’ button.

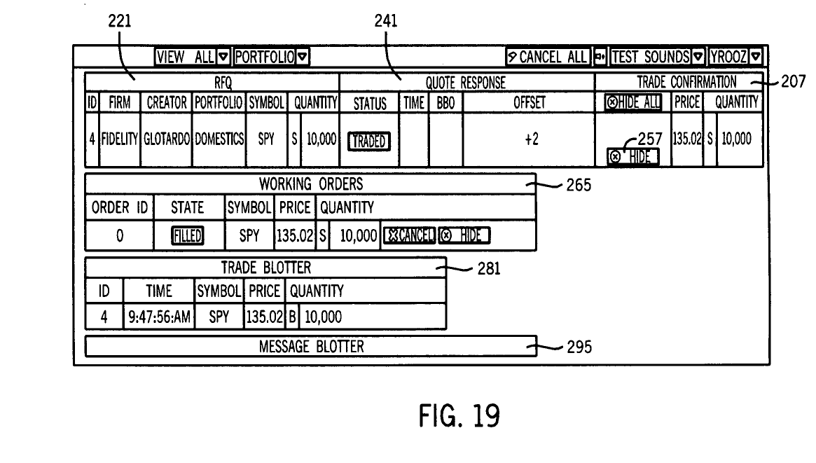

Referring to FIG. 19, a screen shot showing a liquidity provider ‘trade accepted’ state is seen. Once a trade has been successfully completed, it enters the inactive ‘trade accepted’ state. This negotiation can then be hidden using the ‘hide’ button, and will be displayed in the trade blotter.

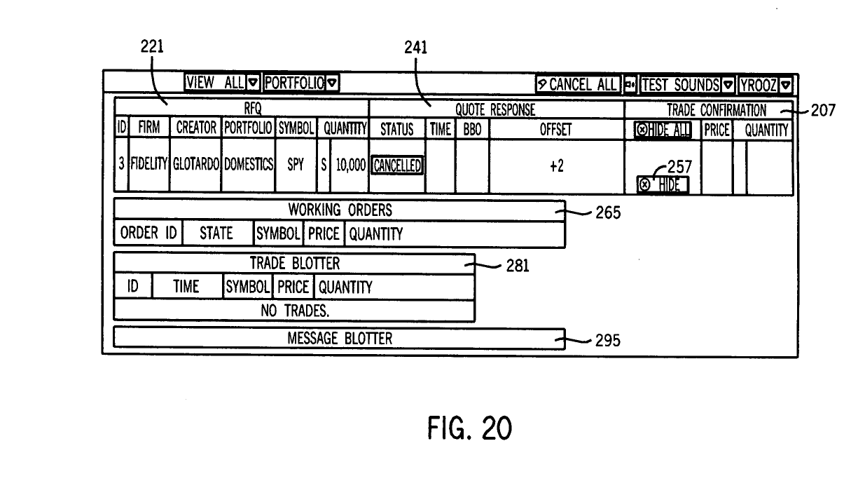

Referring to FIG. 20, a screen shot showing a liquidity provider ‘canceled’ state is seen. If a liquidity provider chooses to cancel an order, the inactive ‘canceled’ state is entered. This negotiation can then be hidden using the ‘hide’ button.

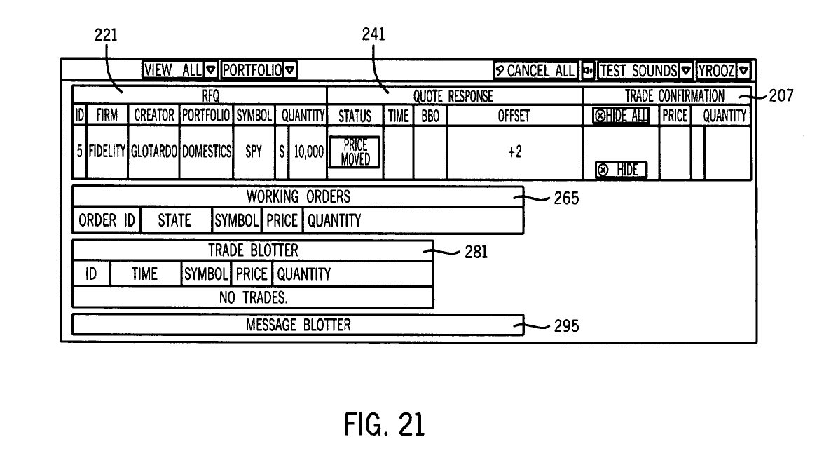

Referring to FIG. 21, a screen shot showing a liquidity provider ‘price moved’ state is seen. This is an inactive state that occurs after a race condition when two events occur simultaneously: the requestor choosing to trade at the same time the liquidity provider was changing their price such that the requestor's limit price would no longer result in a trade.

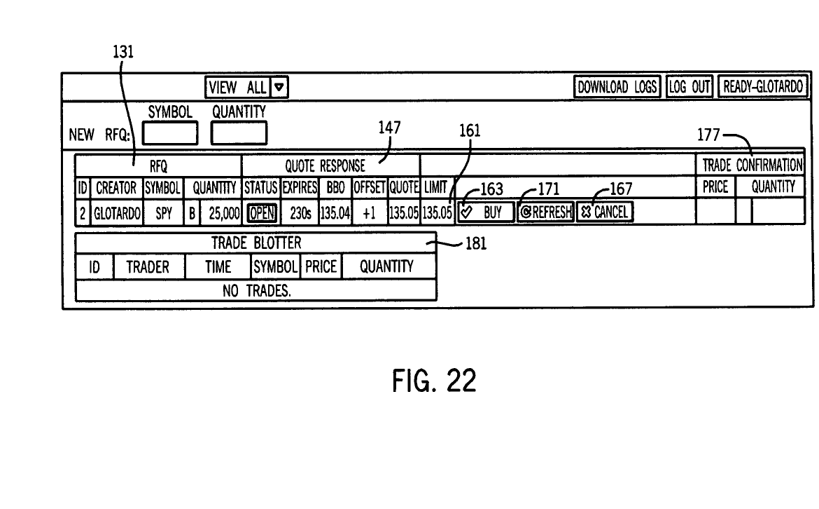

Referring to FIGS. 22-24, screen shots showing a liquidity provider click risk feature are seen. As previously detailed, once the liquidity provider's input device hovers over the ‘trade’ button, a locked-in price shows up in a ‘limit’ column and is equal to the quote price at the time the liquidity provider's input device hovers hovered over the ‘trade’ button. If the input device moves off the ‘trade’ button, the limit price again becomes dynamically linked to the quote price. Once set, this limit price is the worst price at which the requestor will complete the trade; however, the requestor will have the potential for price improvement. Click risk refers to the risk that, between the time that the liquidity provider's input device hovers over the ‘trade’ but before the liquidity provider has executed the trade, the liquidity provider may change the price of the quote.

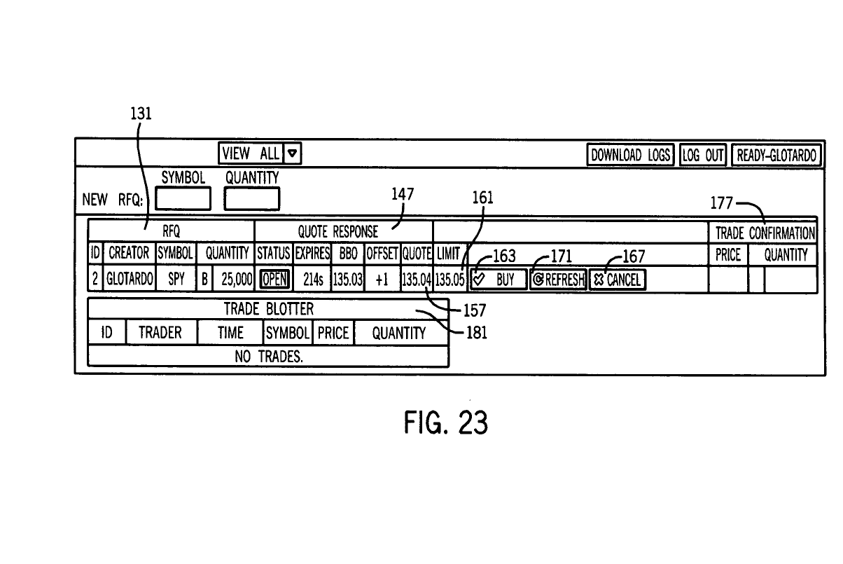

Referring to FIG. 23, once hovered over the ‘trade’ button, the limit price shows up. The limit price is initially equals the quote price. If the quote price improves for the requestor, the ‘buy’ or ‘sell’ (‘trade’ earlier in this paragraph) button is still active and the requestor is still able to click to commence the trade and will receive the improved price.

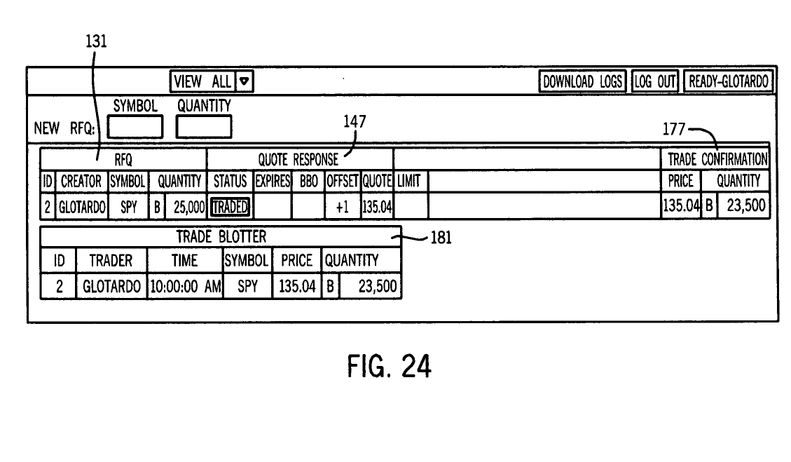

Referring to FIG. 24, the requestor receives the improved price as opposed to a limit price if the requestor chooses to click the ‘buy’ or ‘sell’ button during an episode where the liquidity provider is changing the negotiation price at the same time the requestor is clicking the ‘trade’ button. In this Figure, the quote price moved in favor of the requestor. The limit buy price is still locked at $135.05, as detailed in FIG. 23. The requestor can expect to get $135.04 if the requestor trades at this moment, although the price could move either favorably or adversely as the requestor clicks. Even if this does happen, $135.05 is the worst price the requestor will receive with this limit price locked in. The requestor can refresh the limit price by removing the mouse from the ‘trade’ button and hovering again.

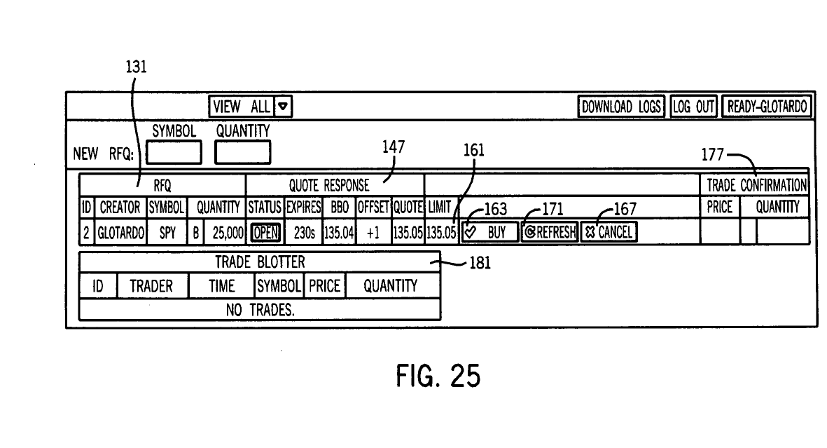

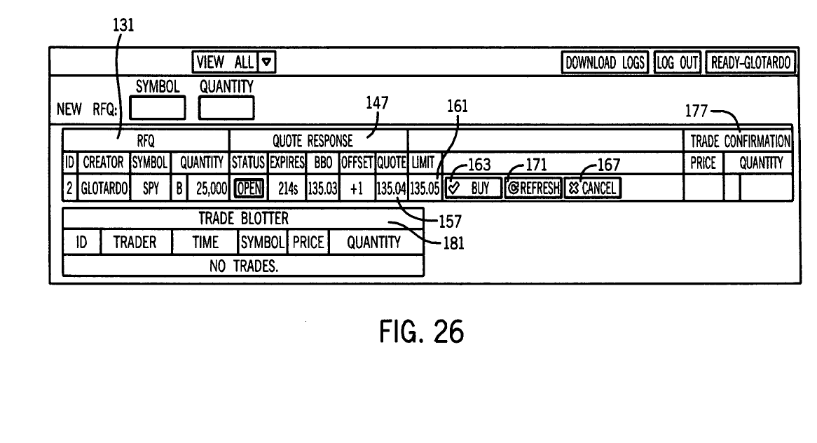

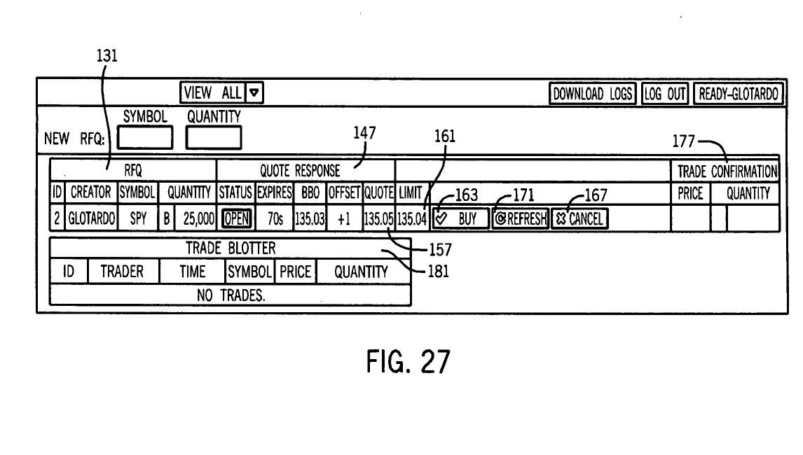

Referring to FIG. 25, a screen shot showing a requestor ‘price block’ feature is seen. The requestor ‘price block’ feature addresses situations where the requestor clicks the ‘trade’ button at the same time the liquidity provider modifies their price to a price at which the requestor is no longer willing to trade. During these particular race conditions, the requestor is not even given the option of attempting to click the ‘trade’ button to protect their price interests and remove any ambiguity of the requestor clicking and expecting to consummate a trade at what they believe to be a price acceptable to them, but in reality has moved away from an acceptable level.

In FIG. 25, the quote price is worse than the limit price (the requestor locked in a limit price to buy $135.04 and the current quote is $136.05). Therefore the ‘trade’ button (‘buy’ in this example) is inactive, protecting the requestor from attempting to trade at a price worse than that at which the requestor has interest. Once the quote price comes back to a level tradable with the limit price, the ‘trade’ button (‘buy’ in this instance) becomes active again.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A peer-to-peer electronic negotiation platform comprising:
providing a network-based platform that enables access via a uniform resource locator on a client device;
the network-based platform further comprising:
a requestor state that allows a requestor to send a request for quote;
a liquidity provider state that displays the request for quote, the liquidity provider state further allowing a liquidity provider to respond with a negotiation price or an ability to decline to enter into a negotiation;
a requestor state in which, in response to the liquidity provider responding with a negotiation price, the requestor is given a specified amount of time to accept or decline the response;
a locked price state where the requestor has signaled a worst price for which the requestor is willing to complete the negotiation;
a liquidity provider state in which the liquidity provider can change the negotiation price of a negotiation that has not been canceled or completed;
a requestor price improvement feature wherein, if the requestor has locked in a limit price and a liquidity provider's price change favors the requestor at the same time the requestor is agreeing to the prevailing negotiation price, the trade can be executed at the new price resulting in a price improvement to the requestor;
further wherein, if the price change has moved the price to a level beyond which the requestor has signaled the desire to trade at the same time the requestor is agreeing to the prevailing negotiation price, the transaction will not occur at the new price and the requestor is protected from the adverse price move; and
wherein the risk of the requestor trading in a situation where the negotiation price has moved outside of their agreed-upon best price is removed.

2. The network-based, over-the-counter, peer-to-peer electronic trading platform of claim 1 further comprising a requestor state that allows a requestor to send a request for more than one quote.

3. The network-based, over-the-counter, peer-to-peer electronic trading platform of claim 1 further comprising a requestor state that allows a requestor to send a request for a portfolio of instruments.

4. The network-based, over-the-counter, peer-to-peer electronic trading platform of claim 1 further comprising the requestor entering orders by selecting an RFQ button and entering into a requestor price protection feature in which:
once the trade button is hovered over, the limit price for the negotiation is fixed to the quote price; and
once set, the limit price is the worst price at which the requestor will complete the trade.

5. The network-based, over-the-counter, peer-to-peer electronic trading platform of claim 4 further comprising if the price improves the requestor can complete the trade.

6. The network-based, over-the-counter, peer-to-peer electronic trading platform of claim 1 further comprising the requestor entering orders by selecting an RFQ button, and entering into a requestor price protection feature in which, once the requestor moves off the trade button, the limit price again becomes dynamically linked to the quote price.

7. The network-based, over-the-counter, peer-to-peer electronic trading platform of claim 1 further comprising, in response to the liquidity provider responding with a desired price, a requestor is provided with a limited time to decide if to accept or decline the quote.

8. The network-based, over-the-counter, peer-to-peer electronic trading platform of claim 7 further comprising, in response to the liquidity provider not being interested or not responding in the limited time of time, the requestor is permitted to re-submit the request for proposal.

9. The network-based, over-the-counter, peer-to-peer electronic trading platform of claim 1 further wherein the network-based, over-the-counter, peer-to-peer electronic trading platform is updated server side.

10. The network-based, over-the-counter, peer-to-peer electronic trading platform of claim 1 further comprising a user accessing the over-the-counter, peer-to-peer electronic trading application via a uniform resource locator located on a device selected from the group comprising smart phones, tablet devices, laptop computers, personal computers, and combinations thereof.

11. The network-based, over-the-counter, peer-to-peer electronic trading platform of claim 1 further comprising the requestor sending a new request for quote by entering a valid ticker symbol in a valid quantity at a valid price.

12. The network-based, over-the-counter, peer-to-peer electronic trading platform of claim 1 further comprising the liquidity provider responding either automatically or manually with a price to the initiator with buttons for offsets from best bid best offer or to any other relevant price of interest, as well as in absolute price terms.

13. The network-based, over-the-counter, peer-to-peer electronic trading platform of claim 1 further comprising a thin, web-based, client-side application, where the trading platform pushing data using bi-directional, full-duplex communications channels to the thin, web-based, client-side trading application wherein a need for polling is not required.

14. A method of providing a network-based, over-the-counter, peer-to-peer electronic trading platform comprising:
enabling a user to access the over-the-counter, peer-to-peer electronic trading application via a uniform resource locator on a client device;
enabling a requestor to send a request for quote;
displaying to a liquidity provider the request for quote,
enabling the liquidity provider to respond with a desired price or decline to enter into a negotiation;
in response to the liquidity provider responding with a negotiation price, enabling the requestor to accept or decline the response in a specified amount of time;
allowing the requestor the ability to indicate a price at which they would immediately agree to a negotiation; and
if prices fluctuate before the requestor responds, enabling the liquidity provider to change the negotiation price;
wherein, if the price change favors the requestor, executing the trade at the new price;
further wherein, if the price change has moved the price to a level beyond which the requestor has explicitly signaled the desire to trade, not executing the trade; and
further wherein, removing a risk of the requestor trading in a situation where the negotiation price has moved outside of their agreed-upon best price.

15. The method of providing a network-based, over-the-counter, peer-to-peer electronic trading platform of claim 14 further comprising the requestor sending a request for more than one quote.

16. The method of providing a network-based, over-the-counter, peer-to-peer electronic trading platform of claim 14 further comprising the requestor sending a request for a portfolio.

17. The method of providing a network-based, over-the-counter, peer-to-peer electronic trading platform of claim 14 further comprising the requestor entering orders by selecting a trade button, once the trade button is hovered over, the limit price for the negotiation is fixed to the quote price, and further once set, this limit price is the worst price at which the requestor will complete the trade.

18. The network-based, over-the-counter, peer-to-peer electronic trading platform of claim 17 further comprising if the price improves the requestor can complete the trade.

19. The method of providing a network-based, over-the-counter, peer-to-peer electronic trading platform of claim 14 further comprising the requestor entering orders by selecting a trade button, and entering into an liquidity provider price improvement feature in which, once the requestor moves off the trade button the limit price again becomes dynamically linked to the quote price.

20. The method of providing a network-based, over-the-counter, peer-to-peer electronic trading platform of claim 14 further comprising, in response to the liquidity provider responding with a desired price, providing a requestor with a limited time to decide to accept or decline the quote.

21. The method of providing a network-based, over-the-counter, peer-to-peer electronic trading platform of claim 20 further comprising, in response to the requestor not being interested or not responding in the limited time of time, permitting the requestor to re-submit the request for proposal.

22. The method of providing a network-based, over-the-counter, peer-to-peer electronic trading platform of claim 14 further comprising updating the network-based, over-the-counter, peer-to-peer electronic trading platform server side.

23. The method of providing a network-based, over-the-counter, peer-to-peer electronic trading platform of claim 14 further comprising enabling a user to access the over-the-counter, peer-to-peer electronic trading application via a uniform resource locator located on a device selected from the group comprising smart phones, tablet devices, laptop computers, personal computers, and combinations thereof.

24. The method of providing a network-based, over-the-counter, peer-to-peer electronic trading platform of claim 14 further comprising enabling the requestor to send a request for quote by entering a valid ticker symbol in a valid quantity at a valid price.

25. The method of providing a network-based, over-the-counter, peer-to-peer electronic trading platform of claim 14 further comprising enabling the liquidity provider to respond with a price to the initiator with buttons for offsets from best bid best offer.

26. The method of providing a network-based, over-the-counter, peer-to-peer electronic trading platform of claim 14 further comprising providing a thin, web-based, client-side application, the trading platform pushing data using bi-directional, full-duplex communications channels to the thin, web-based, client-side trading application wherein a need for polling is not required.
